(19) United States
(12) Patent Application Publication
(10) Pub. No.: US 2021/0029958 A1
(43) Pub. Date: Feb. 4, 2021

(54) SYSTEM FOR FILLING MOLDS WITH CURD TO MAKE CHEESE

(71) Applicant: EQUIPEMENTS TECHNIQUES DES INDUSTRIES ALIMENTAIRES ET CONNEXES TECNAL, Niort (FR)

(72) Inventor: Marc CRAMARD, Niort (FR)

(73) Assignee: EQUIPEMENTS TECHNIQUES DES INDUSTRIES ALIMENTAIRES ET CONNEXES TECNAL, Niort (FR)

(21) Appl. No.: 17/074,069

(22) Filed: Oct. 19, 2020

Related U.S. Application Data
(63) Continuation of application No. PCT/FR2019/050956, filed on Apr. 19, 2019.

(30) Foreign Application Priority Data
Apr. 19, 2018 (FR) 18/53449

(51) Int. Cl. A01J 25/13; A23P 30/10

(52) U.S. Cl. CPC A01J 25/13; A23P 30/10

(57) ABSTRACT

A system for filling molds with a curd/serum mixture includes a feeding device that allows a volume of curd and serum to be collected and distributed in order for same to be poured into a mold. The feeding device includes a hopper that tapers towards a bottom distribution base having distribution ports, molds into which the curd/serum mixture is to be poured, and a distribution plate perforated with orifices, downstream of which the molds are placed during the mold filling process. The feeding device is movable horizontally relative to the distribution plate in a direction of movement and the system is characterized in that the feeding device includes a connection plate which is disposed at least partly around the base of the hopper and is designed to be in contact with the distribution plate when the molds are filled with the curd/serum mixture.

### CROSS-REFERENCE TO RELATED APPLICATIONS

This application is a continuation of International Application No. PCT/FR2019/050956, filed on Apr. 19, 2019, which claims priority to and the benefit of FR 18/53449, filed on Apr. 19, 2018. The disclosures of the above applications are incorporated herein by reference.

### FIELD

The present disclosure relates to the technical field of molding cheese or other equivalent products.

### BACKGROUND

The statements in this section merely provide background information related to the present disclosure and may not constitute prior art.

It is known that the milk which is used in the manufacture of cheese undergoes a certain number of preparations which are successively, in particular in the context of the manufacture of soft paste cheeses, the following:

the pasteurization, aiming at ridding the milk of certain undesirable microorganisms by heating it, the milk intended for the manufacture of cheese being able to go through this step, which is nonetheless not mandatory, depending on whether a cheese is made from raw milk or pasteurized milk;

the ripening, a step during which lactic ferments selected depending on the desired cheese are added to the milk to give the texture and the taste of the cheese;

the curdling, this step consisting in letting the milk coagulate thanks to the action of a rennet, the milk is solidified to become curdled;

the slicing or cutting the curd, also called “cutting of coagulum”: the curd is sliced into small regular cubes with a curd slice;

the molding: once the curd has been obtained and sliced, this mixture of curd and lactoserum or serum is distributed and introduced into molds of varying shapes and sizes depending on the desired shaping;

the draining: once molded, the curd is drained so as to separate it from the serum, also called “whey” which is a liquid resulting from the coagulation of the milk, this making it possible to prolong the conservation of the cheese; and

the demolding.

The step of molding the curd/serum mixture is delicate and important in the cheese process.

In fact, respect for the curd during its transfer into the molds should be ensured, in order to limit the production of “cheese dusts” which result in a loss of yield.

The control of the weight of each cheese should also be ensured, moreover, in particular for most cheeses individually sold.

The composition of the cheeses and their shape tend to be diversified, which further complicates the problem of possible weight dispersions of these cheeses.

The evacuation of the air contained in the molds during the transfer of the curd/serum mixture inside said molds is also a problem given that this transfer is a source of heterogeneity of the obtained cheeses, both in terms of weight and in terms of the quality of the obtained cheese paste. In fact, this is due to bubbles of various sizes being trapped in the curd/serum mixture during this transfer.

To perform the step of molding the curd, it is in particular known to perform this molding either manually or automatically by means of a suitable installation.

Such an installation generally consists of a supplying means making it possible to collect and distribute a volume of curd and of serum to be molded, the supplying means being composed of a hopper converging towards a lower distribution base provided with spill and distribution openings through which the curd and serum mixture flows by gravity.

The installation also comprises molds inside which the curd/serum mixture is intended to be poured.

It is also usual to use a distribution plate, also traditionally called a molding plate, pierced with orifices directly above which the molds are disposed during the molding, this distribution plate making it possible to ensure a distribution of the curd/serum mixture in the various molds provided for this purpose.

Thanks to such an installation, the curd/serum mixture to be molded flows by gravity out of the hopper through the distribution openings and towards the orifices of the distribution plate, which allow the distribution of said curd/serum mixture in the molds.

In a manner known per se, the hopper is moved relative to the distribution plate by means of displacement means. More precisely, the hopper can be driven horizontally by the reciprocating displacement means between two positions so as to pass successively directly above all the orifices of the distribution plate. Alternatively, it is known to displace the assembly formed by the distribution plate and the molds relative to the hopper.

In practice, in this type of installation of the state of the art, the distribution plate consists of a sheet metal part requiring the use of a different plate for each desired cheese format. This requires time and a suitable storage place for these parts.

Moreover, the exhaust of the air contained in the molds during the filling with the curd/serum mixture is generally carried out, in addition to being partially evacuated through holes provided in the molds for draining the curd/serum mixture, between the distribution plate and the hopper.

Nonetheless, the hopper is generally provided at its base, horizontally around the distribution orifices, with a connection plate, making it possible to retain any lateral spill or overflow of the curd/serum mixture out of the orifices of the distribution plate, on its upper surface. Even if this connection plate is very close to the distribution plate, there is a vertical clearance which is appreciably less than a millimeter, for example in the range of 0.5 mm.

In practice during the molding, the exhaust of air which is not evacuated through the draining holes of the molds, then exhausted either between the connection plate and the distribution plate by the aforementioned clearance or, under form of bubbles which go up in the hopper.

Generally, this clearance is configured to be large enough to allow a sufficient amount of air to be exhausted through it, but small enough to limit the amount of produced cheese dust and to limit the amount of curd that could circulate between the distribution plate and the exhaust plate.

Nonetheless, the adjustment of the hopper of the exhaust plate with the distribution plate is generally delicate and dedicated to each distribution plate.

Moreover, the precision of the distribution plate is low with regard to its sheet metal design, the clearance being difficult to control, which leads to a loss of material (curd, cheese dust), and therefore impacts the yield.

Finally, a relatively small vertical clearance between the distribution plate and the connection plate can be at the origin of a hydrostatic sealing phenomenon between these two distribution and connection plates due to a quantity of liquid curd/serum mixture which is engaged in the interstice: the curd/serum mixture then creates a seal in this interstice which promotes the rise of bubbles in the curd/serum mixture contained in the hopper. This is particularly detrimental to the search for the lowest possible standard deviation between the different quantities of curd contained in the molds.

### SUMMARY

This section provides a general summary of the disclosure and is not a comprehensive disclosure of its full scope or all of its features.

The present disclosure provides a solution to resolve all or part of the drawbacks of the prior art, and in particular provides a solution allowing the molding of the curd/serum mixture homogeneously by an automatic installation with low standard deviation results, in particular by weight, between the various cheeses obtained and provides a molding installation easily adaptable to a variety of cheese formats.

In one form of the present disclosure, an installation for molding a curd/serum mixture is provided, the installation comprising:

a supplying device making it possible to collect and distribute a volume of curd and of serum to be molded, the supplying device including a hopper converging towards a lower distribution base provided with distribution openings,

molds inside which the curd/serum mixture is intended to be poured, and

a distribution plate pierced with orifices directly above which the molds are disposed during the molding, the supplying device being horizontally movable with respect to the distribution plate in a direction of displacement.

The installation is improved in that the supplying device comprises a connection plate disposed at least in part around the base of the hopper and arranged to be in contact with the distribution plate during the molding of the curd/serum mixture in the molds. Also, the installation further includes an exhaust system for guiding an air flow expelled by a mold during its filling towards at least one adjacent mold and downstream with respect to the direction of displacement of the supplying device.

Due to the contact between the connection plate and the distribution plate, any overflow and/or any flow of curd/serum mixture on the distribution plate out of the molds is reduced or avoided.

Such an exhaust system specially provided to evacuate the air from the molds during the molding also makes it possible to greatly or even completely limit any creation of bubbles liable to rise in the hopper.

Moreover, due to such an installation, the need to adjust a clearance between the distribution plate and the connection plate is reduced or eliminated and the use of the installation is consequently simplified.

Advantageously, the exhaust system comprises exhaust grooves extending from the lower distribution base of the hopper to said connection plate. Such exhaust grooves make it possible to easily direct the flow of the evacuated air. Moreover, in such a configuration, the risk of the curd entering the grooves and closing them in a sealed manner is very low, which limits the risk of local creation of a hydrostatic seal.

In a particular technical configuration, at least one exhaust groove is located downstream of each of the distribution openings, said grooves extending in a direction substantially parallel to the direction of displacement and such a configuration facilitates the circulation of the air flow expelled downstream.

According to an advantageous characteristic, the connection plate surrounds at least upstream and downstream, preferably over its entire periphery, the lower base of the hopper such that it is in contact with the distribution plate by surrounding on its entire periphery the lower base of the hopper.

Advantageously, exhaust grooves are located downstream and upstream of each of the distribution openings, said grooves extending in a direction substantially parallel to the direction of displacement. Alternatively, or even in addition, other configurations of grooves can be provided, not just parallel, these grooves opening in any event into the downstream mold depending on the direction of operation of the hopper.

In fact, this makes it possible to enhance the molding method given that the movement of the hopper relative to the distribution plate can make reciprocations in the direction of displacement, and in the opposite direction. An exhaust disposed on either side of the hopper relative to the direction of displacement therefore allows the hopper to be used for molding the curd in these two directions of displacement.

In one configuration, the connection plate is a part attached relative to the hopper and in that a seal is interposed between the lower distribution base of the hopper and the connection plate. This further improves the sealing between the connection plate and the base of the hopper so as to limit the loss of curds and cheese dust in particular, while ensuring easy dismounting for cleaning, maintenance or to access the distribution openings.

The supplying device is configured so that the connection plate has a vertical mobility degree with respect to the lower base of the hopper allowing relative movement of these two parts. This makes it possible in particular to not have any clearance between the distribution plate 8 and the connection plate 10.

According to a technical characteristic, the lower base of the hopper and the connection plate each have a lower surface, these said lower faces being flush.

Advantageously, the distribution plate is formed by at least:

a cassette pierced with orifices directly above which the molds are disposed during the molding, and

a frame arranged to border the cassette over its entire periphery,

the cassette and the frame including removable cooperation so that the cassette and the frame are removably secured.

Such a characteristic is particularly advantageous because it enhances changing the formats of the cassettes in an easy and quickly way, without adjustment, of the distribution plate given that the frame carried by the installation remains identical.

According to a technical characteristic, the cassette and the frame each have a substantially flat upper surface, these said upper faces being flush in the assembled position.

In another form of the present disclosure an installation for molding a curd/serum mixture is provided, and the installation includes:

a supplying device making it possible to collect and distribute a volume of curd and of serum to be molded, the supplying device including a hopper converging towards a lower distribution base provided with distribution openings,

molds into which the curd/serum mixture is intended to be poured, and

a distribution plate pierced with orifices directly above which the molds are disposed during the molding, the supplying device being horizontally movable with respect to the distribution plate in a direction of displacement,

the installation being improved in that the distribution plate is formed by at least:

a cassette pierced with orifices directly above which the molds are placed during the molding, and

a frame arranged to border the cassette over its entire periphery,

the cassette and the frame including removable cooperation so that the cassette and the frame are removably secured.

Such a characteristic is desired since even if a distribution plate is more complex to manufacture than a distribution plate formed or made up of a single sheet metal part, this results in easy and quickly format changes, without adjustment, of the cassette(s) adapted to the desired molds. This speed of implementation during a manufacturing process represents a saving in manufacturing cost.

According to particular technical characteristics, the installation according to the teachings of the present disclosure includes all or part of the aforementioned characteristics, taken alone or in combination with respect to each other.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic sectional view of an installation for molding a curd/serum mixture;

FIG. 2 is a perspective diagram of a hopper and a distribution plate of the installation of FIG. 1;

FIG. 3 is a view of an installation for molding a curd/serum mixture according to one form of the present disclosure;

FIG. 4 is a detailed view of the molding installation according to FIG. 3;

FIG. 5 is detailed view of an exhaust system for guiding a flow of air expelled by a mold during its filling of the installation in FIG. 3;

FIG. 6 is another detailed view of an exhaust system for guiding a flow of air expelled by a mold during its filling of the installation in FIG. 3;

FIG. 7 is another detailed view of an exhaust system for guiding a flow of air expelled by a mold during its filling of the installation in FIG. 3; and

FIG. 8 is a bottom view of the supplying means and of a connection plate.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In all of these figures, identical or similar references designate identical or similar members or sets of members.

In the remainder of the present description, the term “curd” will be used to designate indifferently the curd or the curd/serum mixture.

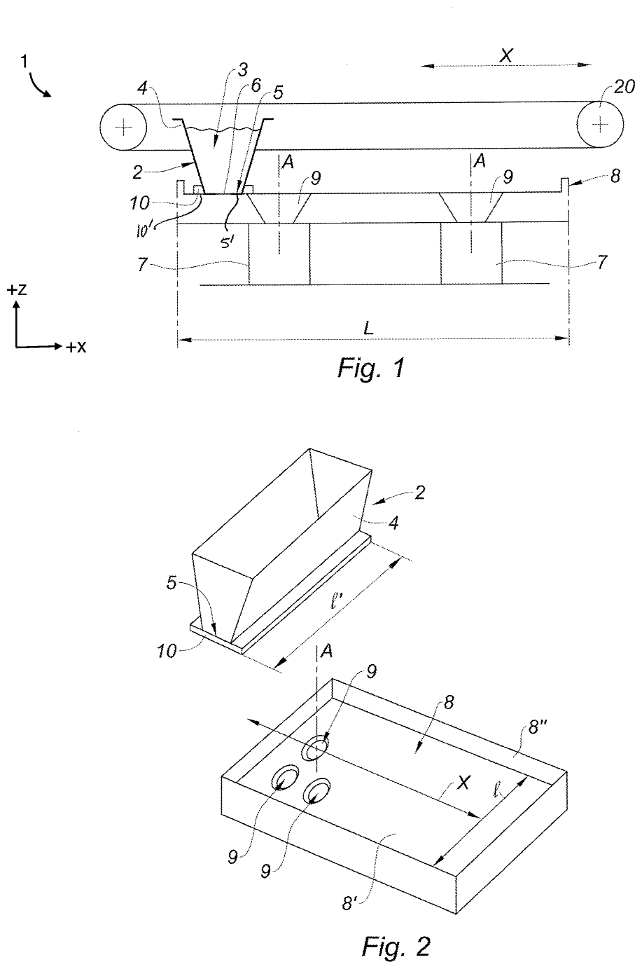

FIGS. 1 and 2 illustrate simplified diagrams of an installation 1 for molding a curd/serum mixture 3.

The molding installation 1 comprises a supplying device 2 making it possible to collect and distribute a volume of curds and of serum 3 to be molded. The supplying device 2 thus contains, at the start of a molding cycle, a predetermined quantity of curd/serum mixture 3 to be molded.

So as to avoid sedimentation of the curd/serum mixture 3 to be molded in the supplying device 2, the latter is, in an implementation mode of the method, filled just before the initiation of a molding cycle, but it can also be supplied and filled continuously during molding.

In the installation 1 represented in FIGS. 1 and 2, the supplying device 2 includes a hopper 4 converging towards a lower distribution base 5 of said hopper 4. The lower distribution base 5 is provided with distribution openings 6 through which the curd/serum mixture is poured through the hopper 4.

The molding installation 1 further comprises a distribution plate 8 pierced with orifices 9 directly below which molds 7 are disposed during molding, inside which the curd/serum mixture 3 is intended to be poured.

These orifices 9 are tapered, their upper opening (+z direction) having a larger area than their lower opening (−z direction).

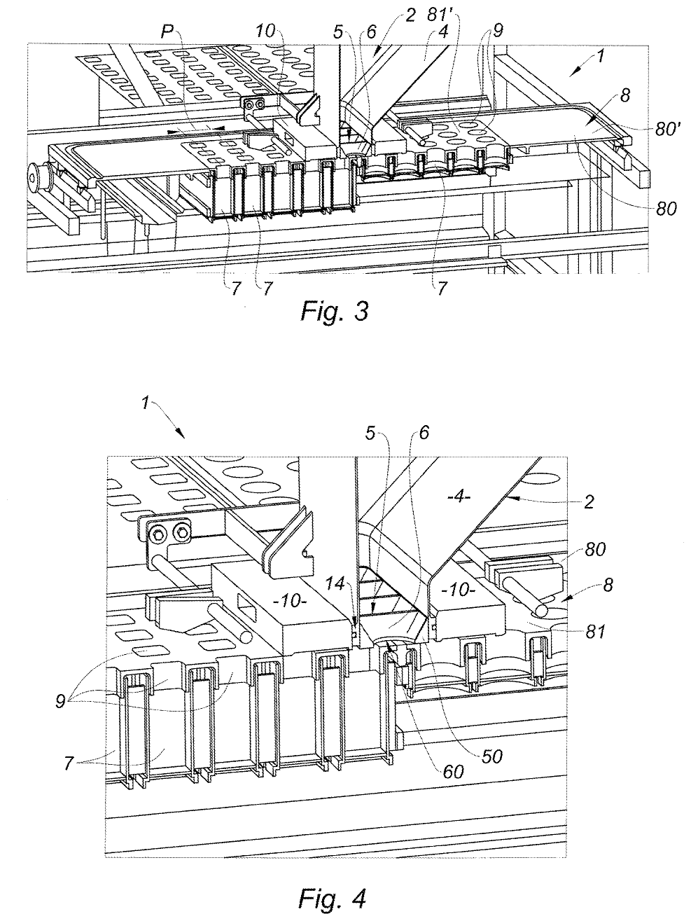

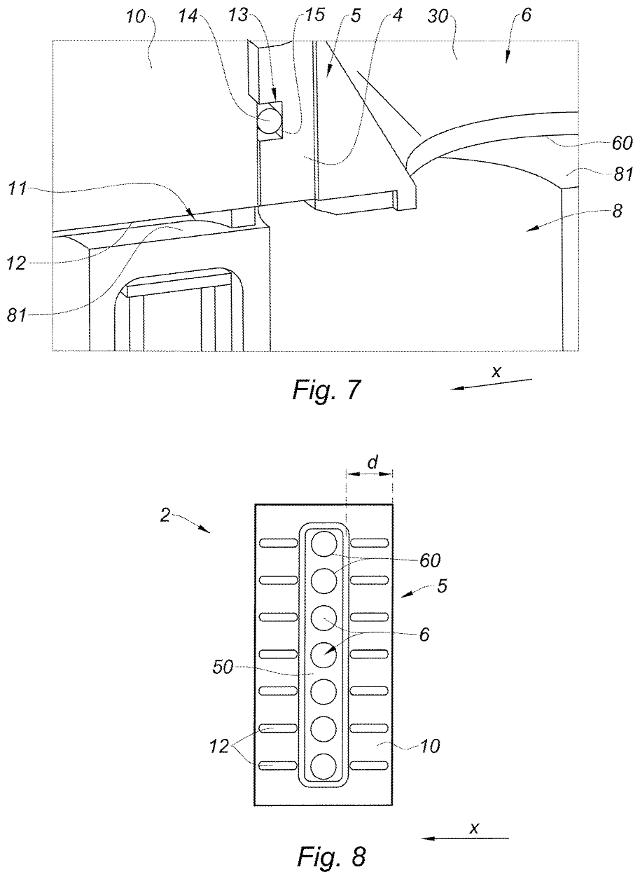

Therefore, the installation 1 is configured so that the curd/serum mixture 3 to be molded flows by gravity, out of the hopper 4, through the distribution openings 6 and then through the orifices 9 of the distribution plate 8, particularly of a cassette 81 (FIG. 4). The shape of the orifices 9 can vary, for example, the orifices 9 can be substantially tubular and have a constant section, as is illustrated with reference to FIGS. 3 to 8.

The hopper 4 is displaceable relative to the distribution plate 8 in a horizontal plane relative to it, by means of a displacement device 20. Particularly, the hopper 4 performs a rectilinear path between two positions, such as a lateral left position (−x direction) and a lateral right position (+x direction). In some variations, the hopper 4 performs a rectilinear path between two extreme or distal positions, such as a lateral left extreme or distal position and a lateral right extreme or distal position.

In the extreme lateral left position, as seen in FIG. 1, or the extreme lateral right position, the hopper 4 is placed above extreme lateral zones of the distribution plate 8, these extreme lateral zones being devoid of orifices 9.

The hopper 4 is driven by the displacement device 20, in reciprocation, between these two extreme positions, so as to pass directly above the orifices 9 in a direction of displacement X.

As shown in FIGS. 1 and 2, the distribution plate 8 has the shape of a relatively thick (z direction), substantially parallelepipedal plate pierced with orifices 9, with vertical axes A substantially parallel to each other and perpendicular to an upper surface 8′ of the distribution plate 8.

In FIG. 2, for better clarity, only three orifices 9 are represented.

Several lines of orifices 9 can be provided, substantially parallel to each other in the direction X of displacement of the hopper 4 on the distribution plate 8, by performing a rectilinear reciprocating movement, that is to say moving back and forth above the distribution plate 8.

In the representation, this direction X corresponds to the largest dimension or length L of the distribution plate 8.

The width I′ of the hopper 4 is substantially equal to the width I of the distribution plate 8, particularly to the width of the upper surface 8′ of the distribution plate 8.

Where appropriate, as represented in FIGS. 1 and 2, substantially vertical lateral walls 8″ form a peripheral edge projecting upwardly (+z direction) from upper surface 8′.

The supplying device 2 comprises a connection plate 10 disposed around the lower distribution base 5 of the hopper 4 and arranged to be in contact with the distribution plate 8 during the molding of the curd/serum mixture 3 in the molds 7.

This connection plate 10 makes it possible in particular to retain a possible lateral spill or overflow of the curd/serum mixture 3 out of the orifices 9 of the distribution plate 8, on its upper surface 8′.

The connection plate 10 surrounds the lower distribution base 5 of the hopper 4 over or around its entire periphery so that it is in contact with the distribution plate 8 on a surface delimiting a closed contour. In this way, the connection plate 10 ensures a sealing of the supplying device 2 with the distribution plate 8 preventing the lateral spill of the curd 3.

Moreover, the connection plate 10 is a part attached relative to the hopper 4, this making it possible to facilitate cleaning and maintenance.

Finally, the supplying device 2 is configured so that the connection plate 10 has a degree of vertical mobility with respect to the lower distribution base 5 of the hopper 4. This makes it possible in particular to reduce or eliminate clearance between the distribution plate 8 and the connection plate 10. Particularly, the installation 1 comprises a bearing device for holding the connection plate 10 in contact with and bearing against the distribution plate 8, or vice versa. And the connection plate 10 is configured so that, under the effect of its weight, the latter remains bearing against the distribution plate 8, that is to say so that the connection plate 10 can continuously bear against the distribution plate 8 during molding. Alternatively, or in addition to, an elastic return device can be provided for this purpose.

The molds 7 are provisioned or positioned below (−z direction) the supplying device 2 and the distribution plate 8 by a lifting system configured to move the molds up (+z direction) and down (−z direction). Several molds 7 are secured together so as to form a block of molds or a “mold block” which is easily handled.

In some variations, the lifting system is configured to maintain contact and permanent bearing of the mold block with a lower face of the distribution plate 8 during molding.

The molding installation 1 comprises position sensors making it possible to know the position of the molds 7 with the distribution plate 8, and in particular the height of the molds 7 with the distribution plate 8 relative to the supplying device 2.

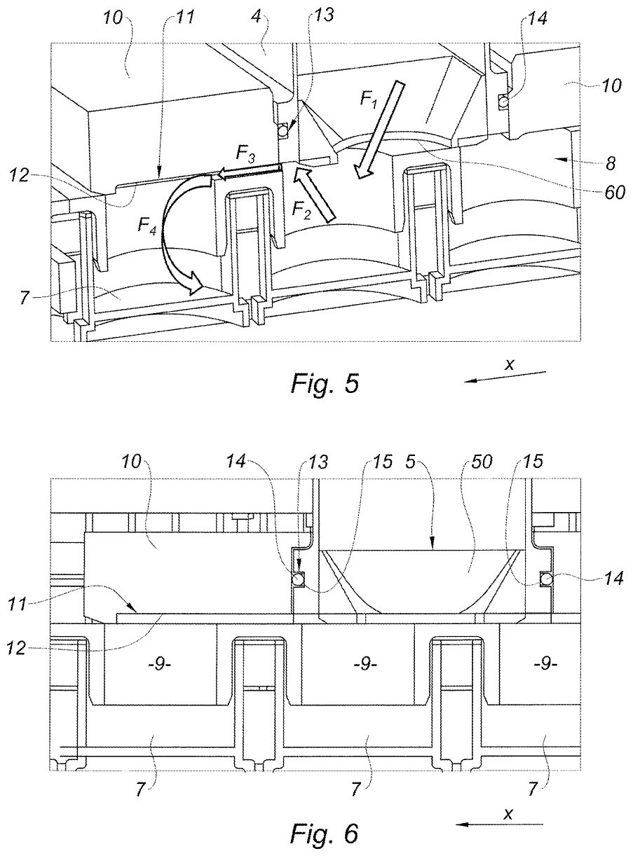

In order to further improve the sealing of the installation 1 between the supplying device 2 and the distribution plate 8, a sealing device 13 (FIG. 5), such as a seal 14 (e.g., an O-ring), is interposed between the hopper 4, at the level of the lower distribution base 5, and the connection plate 10. This seal 14 is a toric seal which, due to its elasticity, matches the shape of the substantially rectangular contour of the hopper 4 which it surrounds.

So that the seal 14 remains stationary, it is housed in a peripheral groove 15 machined laterally around the hopper 4, at the level of its lower distribution base 5.

In some variations the lower distribution base 5 comprises a stand 50 in which the distribution openings 6 are formed, which is positioned while being framed, between the lower walls of the hopper 4 forming an entrance having a substantially rectangular section. Particularly, the stand 50 is free between the lower walls of the hopper 4 at the level of the lower distribution base 5. Indeed, the presence of a clearance allows in particular the dismounting and the cleaning. The stand 50 rests, under the effect of its own weight, on the distribution plate 8. In this way, the connection plate 10 and the stand 50 of the lower distribution base 5 both rest on the distribution plate 8 during the molding, this under the effect of their own weight.

Moreover, in order to improve the distribution or spill of the curd through the distribution openings 6, the latter has a substantially funnel shape, that is to say that the distribution orifices 6 converge downwards, therefore towards the connection plate 10. As can be seen for example in FIGS. 5 and 6, the distribution orifices 6 have a frustoconical shape with an upper opening being of larger section than their lower opening.

The connection plate 10 and the stand 50 also have a predetermined degree of vertical mobility so that contact between the stand 50 and the distribution plate 8 on the one hand and the connection plate 10 and the distribution plate 8 on the other hand, is maintained. In this way, an exhaust system 11 remains effective during the molding.

The peripheral groove 15 inside which the seal 14 is housed is here formed more precisely by a cavity in the lower wall of the hopper 4.

As illustrated in more detail in FIGS. 3 to 7, the installation 1 comprises the exhaust system 11 for guiding a flow of air expelled by a mold 7 during its filling towards at least one downstream mold 7.

The term “downstream” is understood here with respect to the direction of displacement X of the hopper 4 with respect to the distribution plate 8.

The exhaust system 11 comprises exhaust grooves 12 extending from the lower distribution base 5 of the hopper 4, particularly from the stand 50, to said connection plate 10. These grooves extend particularly under the lower distribution base 5 and the connection plate 10.

The lower distribution base 5, and particularly the stand 50, is in contact during molding with the distribution plate 8 in the same way that the connection plate 10 is in contact with the distribution plate 8 during this operation. In this way, the path for the air evacuated from the mold 7 during the molding is delimited by the exhaust groove(s) 12.

The distribution plate 8 has particularly a succession of rows of orifices 9, each spaced apart from one another by a certain pitch ‘P’ (see FIG. 3), the connection plate 10 extending longitudinally at least downstream, but preferably also upstream, over a distance ‘d’ (see FIG. 8), for example at least equal to the value of the pitch P.

In this way, when the distribution openings 6 are perfectly aligned vertically with the orifices 9 of the distribution plate 8, the sealing is ensured between the distribution plate 8 and the connection plate 10 and the air contained in the mold 7 can escape, during its filling by spill of the curd/serum mixture 3, only through the exhaust grooves 12.

A symmetry of the connection plate 10 and the exhaust system 11 upstream of the lower distribution base 5 with the connection plate 10 and of the exhaust system 11 downstream allows ensuring enhanced operation of the exhaust system 11 when the hopper moves back and forth over the distribution plate 8 in the direction of displacement, in both directions. This makes it possible to optimize the cheese manufacturing time.

The exhaust system 11 thus makes it possible to guide a flow of air expelled by a mold 7 during its filling towards at least one downstream mold 7, in either direction of the displacement of the hopper 4 relative to the distribution plate 8.

In one configuration, as is particularly visible in FIG. 8, an exhaust groove 12 is located downstream, and upstream by symmetry, of each of the distribution openings 6, said grooves 12 extending in a direction substantially parallel to the direction of displacement X.

In this way, the path of the air between the mold 7 in the process of being filled and its evacuation is reduced and the risk of the air flow being dispersed, for example by going up into the hopper 4, is reduced.

Moreover, the lower distribution base 5 of the hopper 4 and the connection plate 10 each have a lower surface 5′, 10′, these said lower surfaces 5′, 10′ being flush.

The lower wall of the hopper 4 surrounding the stand of the lower distribution base 5 has an end disposed substantially above these lower surfaces 5′, 10′ so as not to create an obstacle in the exhaust grooves 12. It will be noted that this lower wall of the hopper 4 surrounding the stand could have such an end flush with the lower surfaces 5′, 10′ but in this case, portions of grooves are machined in this wall to ensure the continuity of the exhaust grooves 12 between the lower distribution base 5, particularly the stand 50 and the connection plate 10.

The distribution plate 8 is formed by one or more cassette(s) 81 pierced with orifices 9 directly above which the molds 7 are disposed during molding, and a frame 80 arranged to border the cassette 81 over or around its periphery when it is alone, or all of the cassettes 81 when there are multiple.

The cassette 81 and the frame 80 include removable cooperation structure 82 so that the cassette 81 and the frame 80 are removably secured.

In this way, adjustments of the installation 1 relative to the distribution plate 8 are made on the frame 80 which does not change, and it is possible to easily change cassettes 81 depending on the cheese to be manufactured. In other words, this offers the possibility of changing the formats of the cassettes in an easy and quick way, without adjustment, of the distribution plate 8, given that the frame 80 carried by the installation 1 remains identical.

The cassette 81 and the frame 80 each have a substantially flat upper surface 80′, 81′, these said upper surfaces 80′, 81′ being substantially flush in the assembled position.

During the operation of the installation 1, the curd 3 arrives in the hopper 4 where it is kept at a constant level.

The frame 80 of the distribution plate 8 which supports the two or more cassettes 81 is fixed. The lower distribution base 5 of the hopper 4 which distributes the curd 3 is movable and is displaced by a horizontal movement above the cassettes 81 as well as the frame 80.

Under the effect of the displacement of the hopper 4 from right to left, along its direction of displacement X, the curd 3 falls into the molds 7.

The connection plate 10, which is displaced with the lower distribution base 5 of the supplying device 2 is placed on the distribution plate 8. A curd sealing is produced between the hopper 4, the connection plate 10, and the distribution plate 8, particularly between the frame 80 and the cassettes 81.

The distribution plate 8, particularly the cassette 81, as well as the connection plate 10, condition the flow of the curd 3 in the molds 7 by allowing the air to exhaust via the exhaust system 11.

The association of the cassette 81 with the connection plate 10 allows the evacuation of the air which is inside the mold 7 via the exhaust grooves 12 located below the connection plate 10 thus allowing the air to exhaust towards the downstream mold 7 depending on the direction of displacement.

This leak management allows the curd 3 which exhausts (cheese dust) to remain in the mold 7 and thus improves the yield of the installation 1 by limiting or even eliminating product losses.

More precisely, the contact maintained between the connection plate 10 and the upper surface 8′ of the distribution plate 8, particularly the upper surface 81′ of the cassette 81, allows enhanced metering of the volume of curd 3 in the molds 7 while reducing product losses. The sealing between these elements 8, 10 in particular is thus well controlled.

The contact between the lower distribution base 5, particularly the stand 50, and the distribution plate 8 is at least applied to a closed periphery of each of the distribution openings 6. More generally, the stand 50 of the lower distribution base 5 is arranged so that the contact is ensured with the distribution plate 8, particularly its upper surface 8′, 80′, 81′, at this closed periphery delimiting the distribution opening 6 during the molding. Of course, the contact is not ensured on this closed periphery when at least one portion of this periphery is directly above an orifice 9 of the distribution plate 8 during the displacement of the hopper 4.

This is also the case with the closed periphery of the connection plate 10 which is arranged to be in contact with the distribution plate 8, particularly its upper surface 8′, 80′, 81′.

As illustrated in FIG. 5, the arrow F1 represents the curd 3 which falls into the mold 7, the arrows F2, F3 and F4 for their part illustrate the air which exhausts through the exhaust groove 12 located under the connection plate 10. In this case, the hopper 4 is displaced from right to left in a direction of displacement X which is substantially rectilinear.

In order to improve the dosage, a weighing device is provided on the installation, this device allowing the weighing of the molds during the filling.

The weighing device is preferably integrated into the so-called “up and down” lifting system so that it is possible to know the weight of a block of molds when the molds are filled during the descent of all the molds towards and on an evacuation conveyor.

The present disclosure therefore provides an improvement of the standard deviations during the molding of cheese curds in molds by reducing the product losses and by improving the adequacy of the volume of curd dosed and the volume of the mold.

The present disclosure is described in the foregoing by way of example. It is understood that one skilled in the art is in a position to produce various variants of the teachings of the present disclosure without departing from the scope of the thereof.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An molding installation for molding a curd/serum mixture, the installation comprising:
a supplying device configured to collect and distribute a volume of curd and serum to be molded, the supplying device including a hopper converging towards a lower distribution base provided with distribution openings;
molds inside which the curd/serum mixture is intended to be poured;
a distribution plate pierced with orifices directly below which the molds are disposed during the molding, the supplying device being movable horizontally with respect to the distribution plate in a direction of displacement; and
an exhaust system for guiding a flow of air expelled by a mold during its filling towards at least one adjacent mold,
wherein the supplying device comprises a connection plate disposed at least in part around the lower distribution base of the hopper and configured to be in contact with the distribution plate during the molding of the curd/serum mixture in the molds, the installation further comprising.

2. The molding installation according to claim 1, wherein the exhaust system comprises exhaust grooves extending from the lower distribution base of the hopper towards the connection plate.

3. The molding installation according to claim 2, wherein at least one exhaust groove is located downstream of each of the distribution openings, the at least one exhaust groove extending in a direction substantially parallel to the direction of displacement.

4. The molding installation according to claim 1, wherein the connection plate surrounds at least upstream and downstream the lower distribution base of the hopper.

5. The molding installation according to claim 4, wherein the connection plate surrounds a periphery of the lower distribution base of the hopper.

6. The molding installation according to claim 4, wherein exhaust grooves are located downstream and upstream of each of the distribution openings and the exhaust grooves extend in a direction substantially parallel to the direction of displacement.

7. The molding installation according to claim 1 further comprising a seal interposed between the lower distribution base of the hopper and the connection plate.

8. The molding installation according to claim 1, wherein the lower distribution base of the hopper and the connection plate each have a lower surface and the lower faces are flush with each other.

9. The molding installation according claim 1, wherein the distribution plate comprises:
a cassette pierced with orifices directly below which the molds are disposed during the molding; and
a frame arranged to border the cassette around a periphery of the cassette,
wherein the cassette and the frame comprise a removable cooperation structure so that the cassette and the frame are removably secured.

10. The molding installation according to claim 9, wherein the cassette and the frame each have an upper surface which is substantially flat and the upper surface are substantially flush with each other in an assembled position.

11. A molding installation for a curd/serum mixture, the molding installation comprising:
a supplying device configured to collect and distribute a volume of curd and of serum to be molded, the supplying device comprising a hopper converging towards a lower distribution base provided with distribution openings;
molds inside which the curd/serum mixture is poured; and
a distribution plate pierced with orifices directly below which the molds are disposed during the molding, the supplying device being movable horizontally with respect to the distribution plate in a direction of displacement,
wherein the distribution plate comprises a cassette pierced with the orifices directly below which the molds are disposed during the molding and a frame arranged to border the cassette around its periphery, the cassette and the frame including a removable cooperation structure so that the cassette and the frame are removably secured.
